(19) United States
(12) Patent Application Publication
(10) Pub. No.: US 2010/0241480 A1
(43) Pub. Date: Sep. 23, 2010

(54) System and Method for Dynamic Manipulation of Data Describing User Availability

(75) Inventors: Alexandre Rokhlin, Waterloo (CA); Nataliya Martsyna, Waterloo (CA)

Correspondence Address: The Danamraj Law Group, PC/RIM;Attn: Reba Pieczynski, Premier Place, Suite 1450, 5910 N. Central Expressway, Dallas, TX, 75206, US

(73) Assignee: RESEARCH IN MOTION LIMITED, Waterloo (CA)

(21) Appl. No.: 12/650,244

(22) Filed: Dec. 30, 2009

Related U.S. Application Data
(60) Provisional application No. 61/141,864, filed on Dec. 31, 2008.

(51) Int. Cl. G06Q 10/00; G06F 17/30; G06F 7/00; G06F 15/16

(52) U.S. Cl. 705/8; 707/803; 709/204; 709/219; 707/E17.033

(57) ABSTRACT

In one embodiment, a scheme is disclosed for processing data in relation to a user's availability. The data relates to one or more time slots identified as available or unavailable, each time slot having a start time and an end time as well as an availability status indicator. The scheme involves determining an earliest of start times and a latest of end times associated with the time slots, and storing only the earliest of start times and latest of end times for the user so as to condense the availability information on a user-by-user basis.

### PRIORITY UNDER 35 U.S.C. §119(e) & 37 C.F.R. §1.78

This nonprovisional patent application claims priority based upon the following prior U.S. provisional patent application(s): (i) “SYSTEM AND METHOD FOR DYNAMIC MANIPULATION OF DATA DESCRIBING USER AVAILABILITY,” Application No. 61/141,864, filed Dec. 31, 2008, in the name(s) of Alexandre Rokhlin and Natasha Martsyna; each of which is hereby incorporated by reference.

### FIELD OF THE DISCLOSURE

The present patent disclosure generally relates to data manipulation techniques. More particularly, and not by way of any limitation, the present patent disclosure is directed to a system and method for dynamic manipulation of data describing user availability.

### BACKGROUND

In the present electronic age, many individuals and organizations maintain and schedule their appointments, meetings, conferences, other engagements, and the like through a suitable application (e.g., a calendar/scheduling system application) in conjunction with one or more information appliances such as, e.g., computers, servers, and mobile communications devices. Requests are often made in a business environment, for example, by an individual regarding the availability of other individuals with respect to a time-based event or activity, e.g., an appointment or a meeting request. The availability data of users, whether in relation to a calendaring system, a mail application, or a personal information manager (PIM) application, may in some instances be presented as a set of time ranges, which are organized in a collection. Each of the time ranges describes the time slots where a user indicates he or she is, or is not, available. The user availability data supported by the applications potentially contain an extremely large list of time ranges and significant data accompanied with those ranges, such as dates, times, locations, descriptions, status flags, and various other notes or files. The magnitude of information and data involved with an application for many users is therefore significant and requires large amounts of data storage.

As users maintain their individual availability information, time ranges of the users' unavailability or availability are often added to existing collections, with a new data point added for each start and end time. Such newly added time ranges increase the amount of data points that are associated with and stored for the collection. In addition, many users desire to have remote access to the application, which may be embodied in a server-based environment, via a mobile communications device in order to initiate a time-based event. The transmission of availability information for multiple users therefore requires a significant amount of traffic, which can be particularly relevant in a wireless environment. The addition of new time ranges to a collection for a user's availability would place further demands on data storage and transmission capabilities.

### BRIEF DESCRIPTION OF THE DRAWINGS

A more complete understanding of the embodiments of the present patent disclosure may be had by reference to the following Detailed Description when taken in conjunction with the accompanying drawings wherein:

FIG. 1 depicts an example network environment including a wireless network wherein an embodiment of the present patent application may be practiced;

FIG. 2 depicts a software architectural view of a mobile communications device according to an embodiment;

FIG. 3 depicts a flowchart according to one embodiment for storing and transmitting user availability data;

FIG. 4 depicts a block diagram of an example system according to an embodiment;

FIG. 5 depicts a schematic representation of an example data structure with mapping features;

FIGS. 6A and 6B depict an example of availability data before and after processing, respectively;

FIGS. 6C and 6D depict another example of availability data before and after processing, respectively;

FIG. 7 depicts a block diagram of a mobile communications device according to one embodiment;

FIG. 8 depicts a flowchart according to one embodiment for providing condensed availability data with respect to a time-based event transaction; and

FIGS. 9A and 9B depict examples of data structures according to one embodiment with respect to uncondensed user availability information.

### DETAILED DESCRIPTION OF THE DRAWINGS

The present patent disclosure is broadly directed to a scheme that facilitates reduction of the amount of user availability information required for storage, as well as the amount of traffic necessary for transmission of such information to a recipient device such as, e.g., a desktop computer, a mobile communications device, or a network node. Embodiments are described that are designed to manipulate and condense or compress the data which identifies and describes user availability with respect to a suitable application (e.g., a calendaring or scheduling application). When requests are made by an individual regarding the availability of others for effectuating a time-based event (e.g., an appointment or a meeting request), the condensed data may be transmitted from the server.

In one aspect, an embodiment of a computer-implemented method is described for processing availability data of a user, wherein the availability data relates to one or more time slots in a time range associated with the user, each time slot having a start time and an end time. The claimed embodiment comprises one or more of the following features and is not necessarily limited thereto: selecting a subset of time slots for compression; determining an earliest of start times and a latest of end times associated with the subset of time slots; and storing only the earliest of start times and the latest of end times associated with the subset of time slots for the user to condense the availability data. In one implementation, the embodiment may include transmission of the condensed data to another party. In another implementation, the availability data, i.e., the start times and end times, may be stored in a data structure, such as a Standard Template Library (STL) map data structure, as a collection structure to hold time ranges.

In another embodiment, a computer-implemented method is described for processing availability information relating to a user. The claimed embodiment comprises one or more of the following features and is not necessarily limited thereto: receiving a request for user availability information; obtaining time slot data for the user relating to one or more time-based activities of the user, each time slot having a start time and an end time; selecting a subset of the time slots that are contiguous or overlapping; determining an earliest of start times and a latest of end times for the subset of the time slots; and storing only the earliest start time and the latest end time as a single block of time for the user.

In another aspect, an embodiment of a computer-implemented system is described for processing availability data of a user, wherein the availability data relates to one or more time slots in a time range associated with the user, each time slot having a start time and an end time. The claimed embodiment comprises one or more of the following features and is not necessarily limited thereto: a component configured to select a subset of time slots that are contiguous or overlapping; a component configured to identify an earliest of start times and a latest of end times associated with the subset of the time slots; and a component configured to facilitate storage of only the earliest start time and the latest end time of the time slots for the user.

In a still further aspect, an embodiment of a mobile communications device is described. The claimed embodiment comprises one or more of the following features and is not necessarily limited thereto: a component configured to generate a request for availability information towards a server, the availability information relating to one or more users; and a component configured to process condensed availability information received from the server, wherein the condensed availability information comprises only an earliest of start times and a latest of end times associated with time slots corresponding to multiple time-based activities on a user-by-user basis.

In yet another aspect, an embodiment of a method for scheduling a meeting involving a plurality of users is described with respect to a calendaring system on a remote mobile communications device that is disposed in a communication relationship with a server. The claimed embodiment comprises one or more of the following features and is not necessarily limited thereto: identifying the plurality of users as invitees with respect to the meeting; originating an availability lookup request (ALR) to the server, the ALR including address information of the invitees; receiving condensed availability information relating to the invitees, the condensed availability information identifying a start time and an end time for each invitee, wherein the start time is an earliest of start times of one or more time slots of a time range associated with the each invitee and the end time is a latest of end times of the one or more time slots; and responsive to the condensed availability information, choosing an appropriate time slot for scheduling the meeting and transmitting the appropriate time slot to the server.

Accordingly, with respect to some of the embodiments summarized above, the subset of the user availability slots selected for compression may be overlapping or contiguous (i.e., the availability slot boundaries being adjacent to each other) in certain implementations. Further, the boundaries may occur at whole-hour boundaries or at any fractional component thereof.

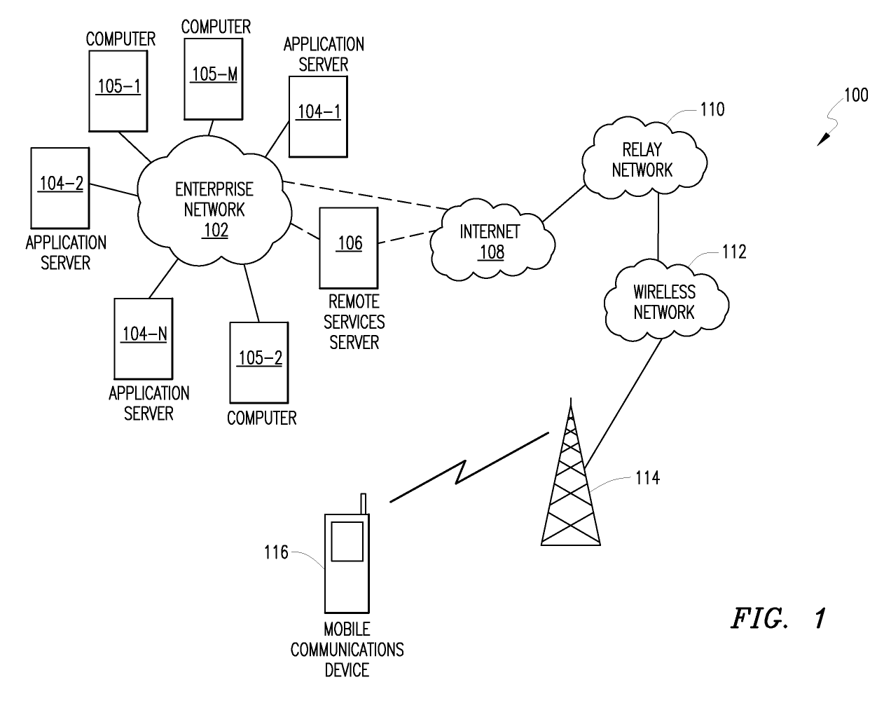

A system and method of the present patent disclosure will now be described with reference to various examples of how the embodiments can best be made and used. Like reference numerals are used throughout the description and several views of the drawings to indicate like or corresponding parts, wherein the various elements are not necessarily drawn to scale. Referring now to the drawings, and more particularly to FIG. 1, depicted therein is an exemplary network environment 100 including a wireless network 112 wherein an embodiment of the present patent application may be practiced. Wireless network 112 may be implemented, for example, as a wireless packet data service network, but other types of wireless networks could also be used. An enterprise network 102, which may be a packet-switched network, can include one or more geographic sites and be organized as a local area network (LAN), wide area network (WAN) or metropolitan area network (MAN), et cetera, for serving a plurality of corporate users. A number of application servers 104-1 through 104-N disposed as part of the enterprise network 102 are operable to provide or effectuate a host of internal and external services such as email, video mail, Internet access, corporate data access, messaging, calendaring and scheduling, information management, and the like. Similarly, a number of information appliances, such as desktop computers, laptop computers, servers and workstations, disposed as part of the enterprise network 102 are operable to access a service application, hosted either internally or externally. Reference numerals 105-1 through 105-M are illustrative of such appliances in one implementation.

Additionally, a remote services server 106 may be interfaced with the enterprise network 102 for enabling a corporate user to access or effectuate any of the services, e.g., from a remote location, using a suitable mobile communications device (MCD) 116. The MCD 116 is typically served by wireless network 112 and one or more base stations 114 thereof, of which only one is shown. Depending on the wireless network technology used, the base station 114 may for example be a base station of a traditional cellular-type wireless network or a packet or data overlay thereof, a WLAN wireless access point, or another type of radio transmitting and receiving facility. In some implementations, the wireless network 112 may be an element of or integrated with the enterprise network 102. In other implementations, the wireless network 112 may be external to the enterprise network 102, and may be realized as, for example, a carrier-operated cellular-type wireless network or a packet or data overlay thereof, a WLAN access point, or some other wireless network facility. The wireless network 112 may interface with the enterprise network 102 directly, or via one or more shared or non-shared external facilities, which may include IP-based packet networks such as the public Internet 108, a relay network 110, or other networks (not shown). The remote service server 106 may optionally serve as an intermediary between the enterprise network 102 and external networks. Accordingly, the paths between the enterprise network 102 and an external network are illustratively shown in dashed lines, one of which may involve the remote service server 106.

A secure communication link with end-to-end encryption between an element of the enterprise network 102 (for example, but without limitation, remote services server 106) and the MCD 116 may be established. The secure communications link may be mediated through any external networks, such as the public Internet 108, wireless network 112, and any other intermediaries. In one embodiment, a trusted relay network 110 may be disposed between the Internet 108 and the infrastructure of wireless network 112. In another embodiment, the infrastructure of the trusted relay network 110 may be integrated with the wireless packet data service network 112, whereby the functionality of the relay infrastructure may be consolidated as a separate layer within a “one-network” environment. Additionally, by way of example, MCD 116 may be a data-enabled mobile handheld device capable of receiving and sending messages, web browsing, interfacing with corporate application servers, et cetera, regardless of the relationship between the networks 110 and 112. Accordingly, a “network node” may include both relay functionality and wireless network infrastructure functionality in some exemplary implementations.

For purposes of the present patent application, the wireless network 112 may be implemented in any known or heretofore unknown mobile communications technologies and network protocols, as long as a data service is available therein for transmitting information including, for example, user availability data. For instance, the wireless network 112 may be comprised of a General Packet Radio Service (GPRS) network that provides a packet radio access for mobile devices using the cellular infrastructure of a Global System for Mobile Communications (GSM)-based carrier network. In other implementations, the wireless packet data service network 112 may comprise an Enhanced Data Rates for GSM Evolution (EDGE) network, an Integrated Digital Enhanced Network (IDEN), a Code Division Multiple Access (CDMA) network, a Universal Mobile Telecommunications System (UMTS) network, any 2nd-2.5-3rd- or subsequent Generation networks, a WLAN network employing WIFI or WIMAX technologies, or any other suitable wireless network. As will be seen hereinbelow, the embodiments of the present patent application for manipulating and transmitting user availability information (based on, for example, calendar data, appointment data, meeting schedule data, etc.) with respect to providing a condensed set of availability information to MCD 116 will be described regardless of any particular wireless network implementation.

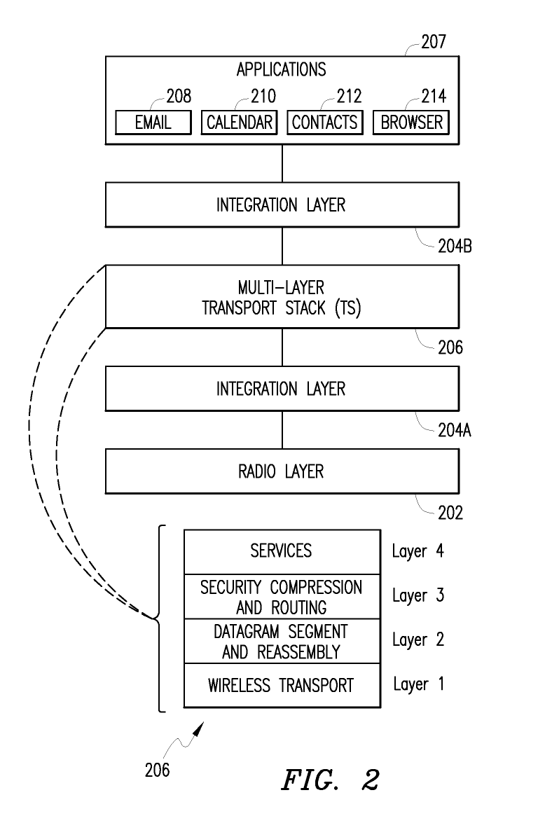

FIG. 2 depicts a software architectural view of an example mobile communications device 116 operable according to an embodiment of the present patent application for receiving condensed availability information with respect to a suitable application program, e.g., a calendar/scheduler application. A multi-layer transport stack (TS) 206 is operable to provide a generic data transport protocol for any type of corporate or user data, including calendar application data and/or user availability data, via a reliable, secure and seamless continuous connection to a wireless packet data service network. As illustrated in the embodiment of FIG. 2, an integration layer 204A is operable as an interface between the MCD's radio layer 202 and the transport stack 206. Likewise, another integration layer 204B is provided for interfacing between the transport stack 206 and the user applications 207 supported on the MCD, e.g., email 208, calendar application 210, contact management 212 and browser 214. Although not specifically shown, the transport stack 206 may also be interfaced with the MCD's operating system. In another implementation, the transport stack 206 may be provided as part of a data communications client module operable as a host-independent virtual machine on a mobile device.

The bottom layer (Layer 1) of the transport stack 206 is operable as an interface to the wireless network's packet layer. Layer 1 handles basic service coordination within the exemplary network environment 100 shown in FIG. 1. For example, when an MCD roams from one carrier network to another, Layer 1 verifies that the packets are relayed to the appropriate wireless network and that any packets that are pending from the previous network are rerouted to the current network. The top layer (Layer 4) exposes various application interfaces to the services supported on the MCD. The remaining two layers, Layer 2 and Layer 3, are responsible for datagram segmentation/reassembly and security, compression and routing, respectively. The specific software architecture is described herein as an example of a suitable software architecture which may be used in conjunction with MCD 116, and an example of and environment in connection with which other elements of the present disclosure may be used. One of skill in the art will appreciate that other software architectures could also be used in MCD 116 without departing from the spirit of the present disclosure.

In one aspect, the present disclosure includes a mobile communications device 116 which interacts with the network as described above with a focus on an application that requires user availability information, e.g., the calendar/scheduler application 210. The mobile communications device 116 in one embodiment comprises a component configured to effectuate a request of availability information from a server relating to one or more users; and a component configured to process availability information received from the server, wherein, as will be described in detail below, the availability information comprises only an earliest of start times and a latest of end times associated with multiple appointments for the user. The calendaring application 210 for a user therefore allows access to such “compressed” availability information for further processing. In one implementation, at least some of the appointments may be overlapping or contiguous (i.e., the appointments being adjacent to one another), or may involve both conditions.

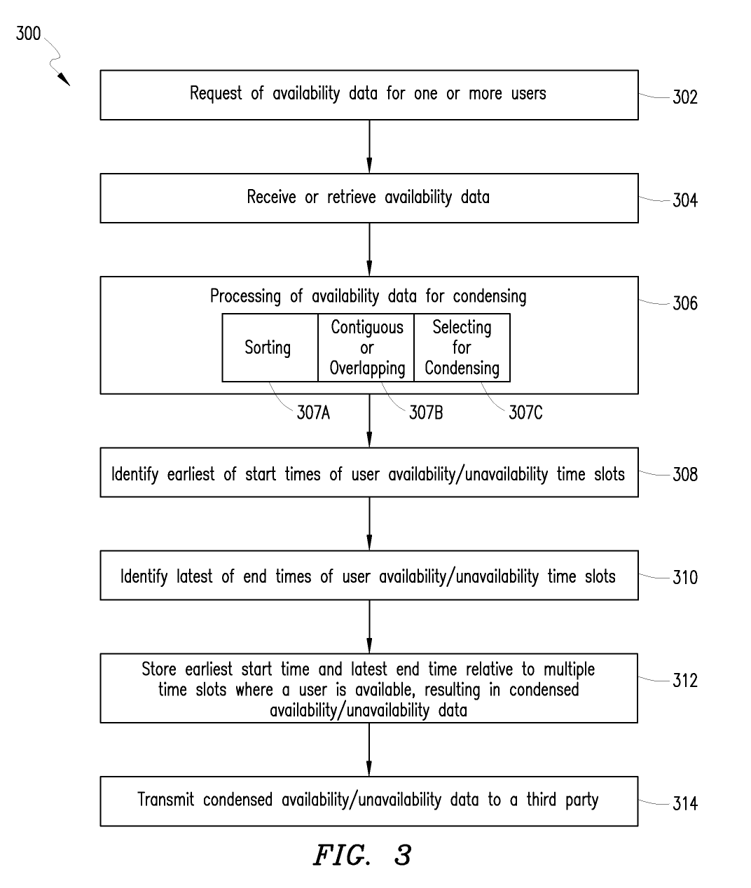

The description of the overall network in FIG. 1 and the software architecture of the mobile communications device from FIG. 2 may used according to one embodiment of the present patent application for the transmission of user availability data from the server to a device. In order to understand the efficiency of data storage, compression and transmission with the process described herein, reference is made to the flowchart of FIG. 3, which outlines an example embodiment 300 described for purposes of the present patent application.

In order to begin the process, a meeting request may be made by an individual with respect to the availability of another user or multiple users. The availability of the parties involved needs to be determined and the meeting request, therefore calls for the current availability data of the other user or multiple other users (block 302). A server-based application, e.g., a calendaring/scheduling system, locates and receives or otherwise obtains the current availability data of the user (block 304) for compression processing (i.e., condensing of data) (block 306). Depending on how the availability data is organized and/or structured (e.g., sorted or not, in a list structure or in a hierarchical nested structure, and the like), additional actions may optionally be performed as part of the processing of block 306. For instance, as will be seen in further detail below, there may be a sorting of the data (block 307A), a determination if the availability time slots are adjacent/contiguous or overlapping (block 307B), and selecting or grouping of only overlapping or adjacent availability time slots (i.e., a subset) as candidates for condensing (block 307C). Based on the foregoing operations, the process identifies the earliest start time of the user availability time slots (block 308) where the user has indicated he or she is unavailable for a particular collection of time ranges. The process then identifies and determines the latest end time of the user availability slots where the user has indicated he or she is unavailable for a particular collection of time ranges (block 310). From this information, the process of the present application stores only the earliest start time and the latest end time (block 312) so as to condense the amount of availability data within a particular collection for a user. This process can be performed for multiple collections and/or for multiple users. It is only these condensed times which are transmitted as a cumulated time block where the user is unavailable back to the individual that originated the meeting request (block 314). Although the aforementioned discussion mentions time slots as times when the user is unavailable, equivalent steps or acts may be used to process times when the user is available. Further, where the unavailability time slots are related to certain time-based events, e.g., appointments or meetings, such appointment data or meeting data may be indicative of unavailability slots for a particular user.

It should be understood by those skilled in the art that requests for two or more users' availability/unavailability may be made and can be included within the scope of the process described by the flowchart of FIG. 3 and may be performed on a user-by-user basis. It should also be understood by those of skill in the art that several variations of the order of the process acts may occur without affecting the results, such as identification and determination of the latest end times (block 310) prior to the identification and determination of the earliest start times (block 308). Similarly, the storage of the earliest start time (block 312) may occur prior to identification of the latest end time (block 310). Further, in some embodiments, not all process acts of the scheme 300 may be required (e.g., there may not be a storing function with respect to the condensed availability data). Accordingly, it should be readily apparent that not all of the acts set forth hereinabove need to be practiced in a particular embodiment.

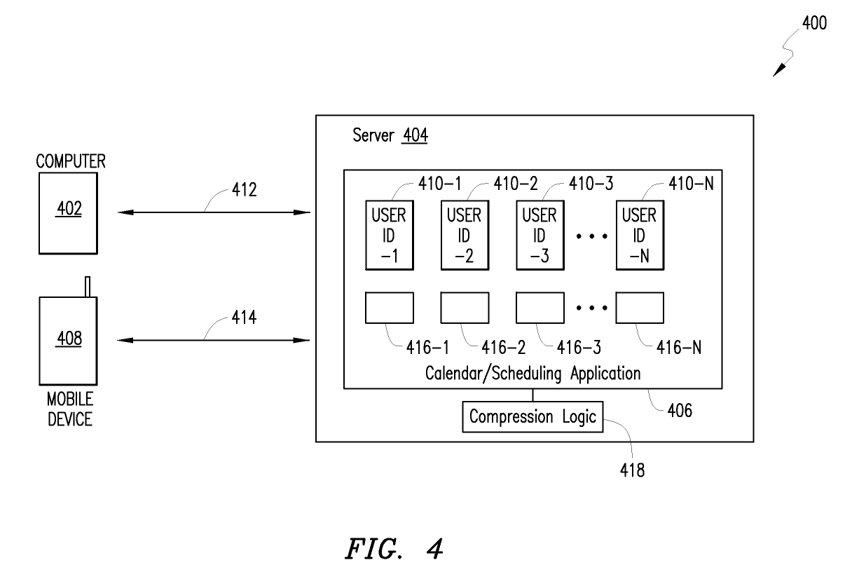

Details of an example system and process will be further described with reference to FIGS. 4, 5 and 6A-6D wherein certain time-based events, e.g., appointments, meetings, conferences, etc., may be used as being indicative of unavailability slots for a particular user. Referring to FIG. 4, there is depicted a block diagram of an example system 400 according to an embodiment of the present patent application. The system 400 includes a host or desktop computer 402, a server 404, and a handheld/mobile communications device 408. The desktop computer 402 is in communication with the server 404 as indicated by a communication path 412 and the mobile communications device 408 is in communication with the server as indicated by a communication path 414. Associated with server 404 is a calendar/scheduling application program 406 which maintains appointment data (i.e., availability data) for multiple individuals. Each of the plurality of users of the calendar/scheduling application program 406 has a user identification as indicated by user ID 1, 2, . . . , N (having reference numerals 410-1 through 410-N). For each of the user ID's 410-1 through 410-N, the application program 406 maintains and stores calendar folders or other suitable database structures 416-1 through 416-N which hold availability data, such as dates and time ranges for meetings, conferences, appointments, travel, and other related information where each user or user's agent may enter and store the time slots when the user is unavailable. In one aspect, the term “appointment data” refers to any data structure stored by a calendaring/scheduling program that includes, but not limited to, date and/or time fields indicative of a time-based activity for a user.

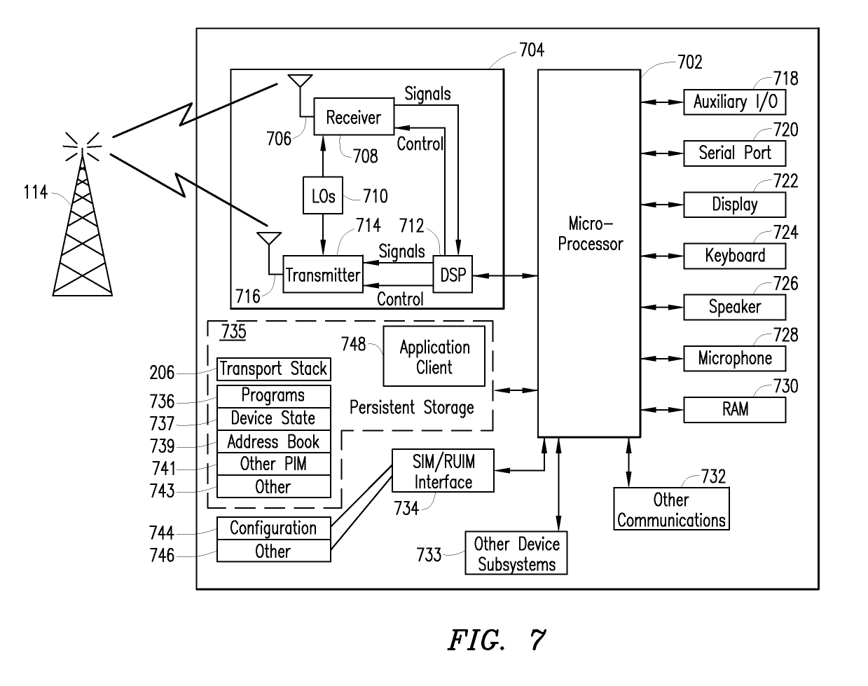

One skilled in the art will recognize that the system 400 of FIG. 4 may be another abstraction of an implementation involving certain elements of the network environment 100 of FIG. 1 and an example MCD described hereinbelow in reference to FIG. 7. For instance, server 404 may be provisioned as an application server (104-1 to 104-N) or the remote services server 106 of FIG. 1.

When a request is made for the availability/unavailability information relating to one or more users based on the information in the application program 406, the availability data which has been stored for each of the requested users 410-1 through 410-N is appropriately processed and transmitted from the server to mobile communications device 408 or the desktop 402. As alluded to previously, there can be an enormous amount of data for storage and transmission, involving many data points even within a single user's collection of appointments, which is further exacerbated where numerous users are involved, for example in an enterprise calendaring system. As described in more detail below, the embodiments of the present application condense the time availability data of the users into a union of ranges with an earliest start time and latest end time for a given collection. As all other intervening points are not critical to determining a user's availability and/or unavailability, those data points do not need to be stored or transmitted, thereby increasing efficiency.

A suitable compression logic module 418 may be provided for dynamic manipulation of the time range data in order to effectuate condensing of user availability information. In the particular embodiment shown in FIG. 4, the compression logic module 418 is associated with the calendar/scheduling application 406 on server 404. The functionality of the compression logic module 418 may also be provided on a separate host computer (e.g., another application server or a remote services server exemplified in FIG. 1) or in conjunction with a network node disposed in suitable communications network infrastructure.

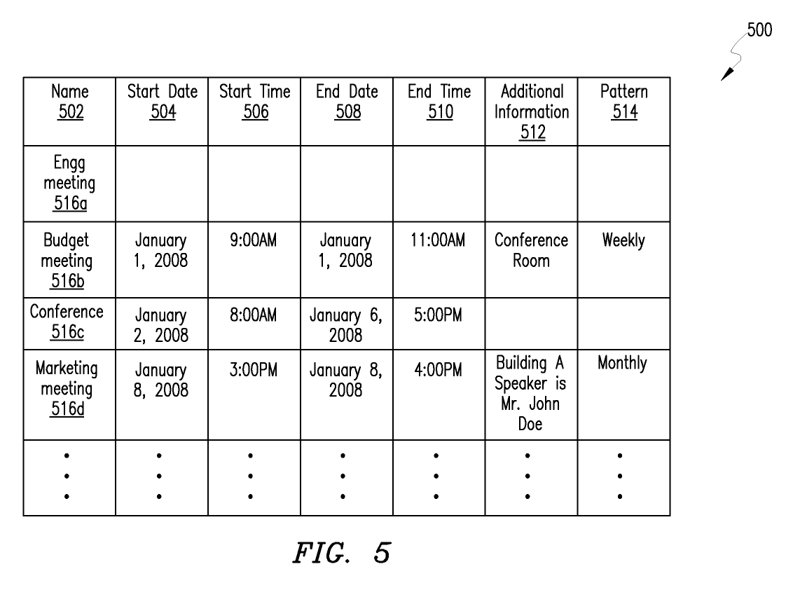

As mentioned above, each user ID 410 of the application program 406 has associated availability data saved in a data structure which can be co-located or distributed. For example, the structure may simply be a data storage facility, such as a database management system, which may be implemented by way of example but not limited to using any suitable database management system having an interface such as Structured Query Language (SQL). FIG. 5 illustrates a table 500 indicative of various types of appointment information provided in one of the user-specific folders 416-1 to 416-N associated with the calendar application program 406. The table 500 may include one or more fields indicated as column headings across the top row of the table. Example fields may include, by way of illustration, name/type of appointment 502, start date of the appointment 504, start time of the appointment 506, end date 508 of the appointment, end time of the appointment 510, any additional information relating to the appointment 512, and a frequency pattern of the appointment 514, such as monthly or weekly, for example. Each row of the table 500 represents a particular appointment description in the calendar database folder 416 for a user ID 410. By way of illustration, an Engineering meeting 516a, a Budget meeting 516b, a Conference 516c, and a Marketing meeting 516d are exemplified in FIG. 5. It should be understood that table 500 is intended as a general representation of information in a calendar/scheduling database and is not an exact physical or logical representation of how the data may actually be stored or managed. The appointment information shown in table 500 of FIG. 5 is representative of the data that may populate the data structures that describe individual appointments for a particular user ID 410. A Standard Template Library (STL) map data structure may be used in an example implementation as a collection structure to hold time ranges associated with such calendaring/scheduling data. Those of skill in the art will recognize that certain additional features may also be made available with STL, such as containers (including map containers), iterators, algorithms, functors, and so on.

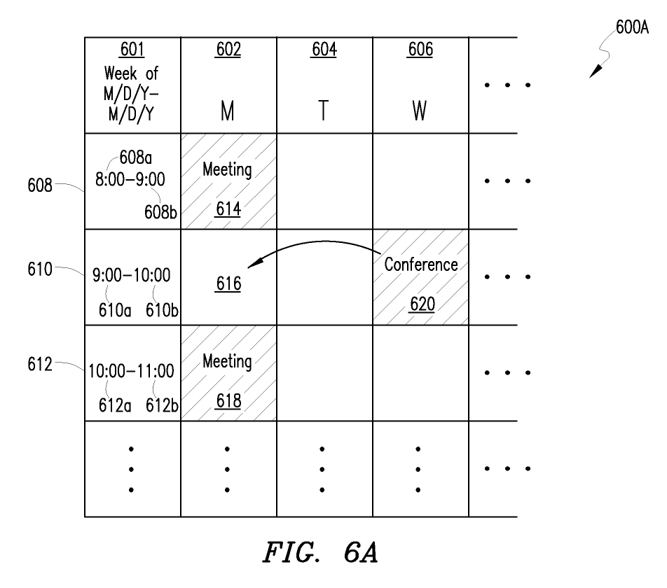

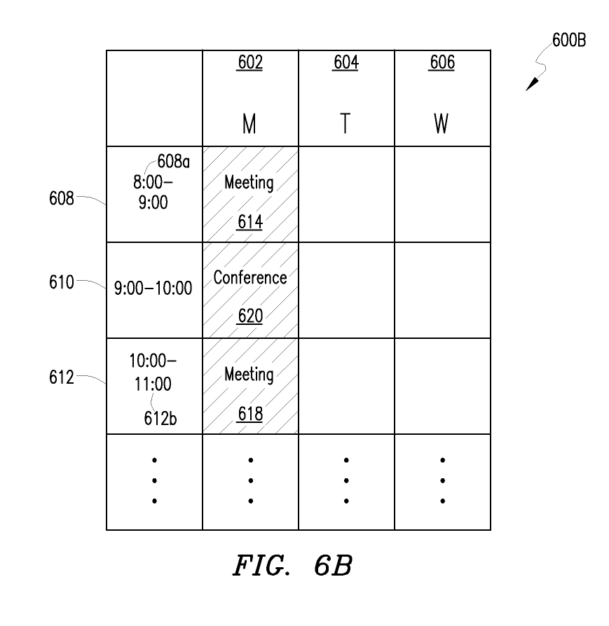

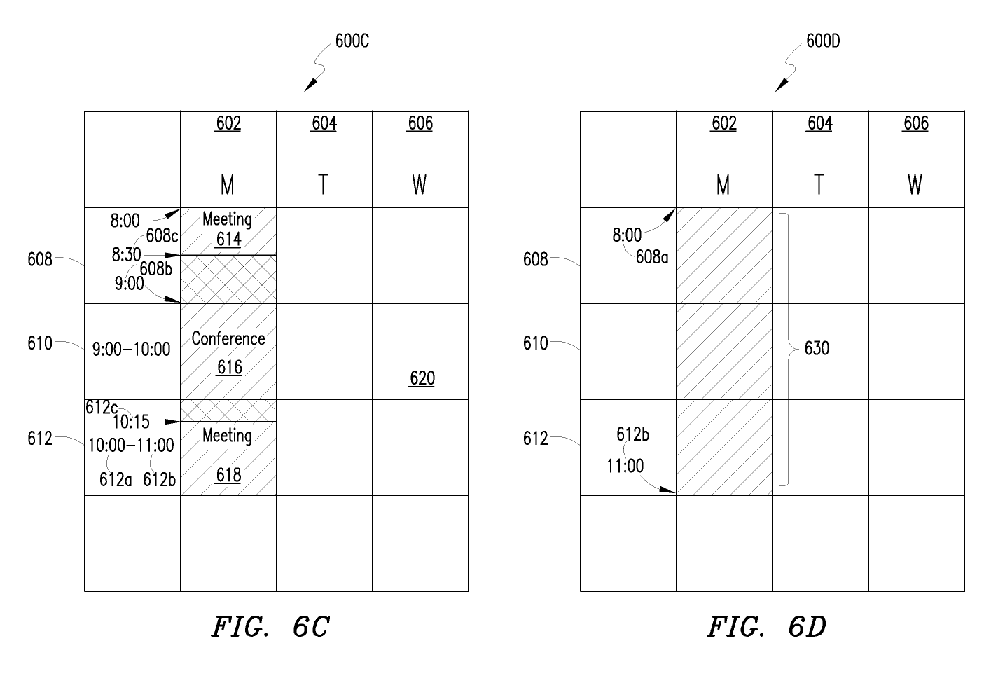

In accordance with an embodiment of the present patent application, the database mapping may include a plurality of timestamp values—for example, at the start of a time range or at the end of the time range or both. The value element of the map is the marker which identifies if this timestamp is a start or end of a time range. When the addition of a new time range is required, as will be described below with respect to examples shown in FIGS. 6A-6D, the processing of the information to manipulate and condense the data points for storage may occur.

By way of illustration, this process occurs by insertion of both the start and end timestamps for the time range into the map. The process then commences to adjust the start time of the range as follows. If there is another timestamp marked as the start of a range, which is smaller, that is earlier, and next to the first start time, the new start time is maintained while the first start time is deleted. Similarly the end time of the range is also adjusted. If there is another timestamp marked as the end of a range, which is greater and next to the first end time, the new end point is maintained while the first end time is deleted. In this manner, the earliest start time and latest of end times for a collection of time slots may be determined. The process may accordingly delete all timestamps between what has been determined to be the earliest start time and the latest end time for a collection of appointments or time slots. This “compression” process, therefore, provides only the earliest start of the time range and the latest end time of the time range for data storage and transmission.

In the mapping of the data, several map iterator objects may be used to point to different map elements to minimize the number of searches and traversals over the map. As a result, the map holds a sequence of timestamps, where for example, odd elements may comprise the starts of some time range and even elements may comprise the ends of some time range. The process ensures that the resulting time range in the map will be the union of a newly added time range and one or more existing overlapping or contiguous time ranges in the map. For example, where there is an overlap between two appointment ranges, there can be union of the ranges, which is, in effect, a cumulative range of two adjacent or contiguous appointments.

Referring to FIGS. 6A and 6B, there is shown in graphical form an example of calendar application information before and after the information is processed, respectively, in accordance with an embodiment of the present application. The dates and times illustrated in FIGS. 6A and 6B are by way of example only and one of skill in the art will understand that the particular dates and times as well as their formats are disclosed as non-limiting examples. An example calendar application information table 600A includes date information 601, in a format such as month/date/and year, and includes days of the week, such as those shown in the top-most row of the calendar application table 600A (i.e., Monday 602, Tuesday 604, Wednesday 606, and so on). Further, the table 600A displays time ranges for the day vertically—that is, appointments in various time slots for a particular day are arranged vertically in the column corresponding to that day. In the particular example shown, time ranges 608, 610 and 612 are shown. Time range 608 includes a start time of 8:00 (see 608a) and an end time of 9:00 (see 608b). Similarly, time range 610 includes a start time of 9:00 (see 610a) and an end time of 10:00 (see 610b). Time range 612 has a start time of 10:00 (see 612a) and an end time (see 612b). One skilled in the art will recognize that although whole-hour boundaries are illustrated in the foregoing example, there is no such limitation with respect to the teachings of the present disclosure and the appointment ranges may therefore have boundaries at fractional-hours as well.

An example of users' appointments is described with reference to FIG. 6A which shows appointment information for multiple appointments, such as meetings and conferences, each of which having a respective start and end time. In FIG. 6A, there is shown a meeting 614 on Monday 602 having a start time of 8:00 (reference numeral 608a) and an end time of 9:00 (reference numeral 608b), each of which times are available as data points in the application and in a data structure. The time range for 8:00 to 9:00 (reference numerals 608a and 608b) is shaded in FIG. 6A to illustrate that the user is unavailable during this time period. Likewise, there is also shown a meeting 618 on Monday 602 having a start time of 10:00 (reference numeral 612a) and an end time of 11:00 (reference numeral 612b), each of which times are similarly stored as data points. The time range for 10:00 to 11:00 (reference numerals 612a and 612b) is shaded in FIG. 6A to illustrate that the user is unavailable during this time period. On Monday 602, however, the user is currently available from 9:00 (reference numeral 610a) until 10:00 (reference numeral 610b), as illustrated by non-shaded block 616. In this case, accordingly, the appointment information indicates that the user is unavailable from the range of 8:00 (reference numeral 608a) to 9:00 (reference numeral 608b) and from 10:00 (reference numeral 610a) to 11:00 (reference numeral 610b) for Monday 602. Data representing this information may be stored as a collection wherein a Standard Template Library Map data structure is used as a collection structure to hold the time ranges.

Again with reference to FIG. 6A, the appointment information indicates that the user is currently unavailable on Wednesday 606 as conference 620 is scheduled from a starting time of 9:00 (reference numeral 610a) to end time of 10:00 (reference numeral 610b). This time range is shaded accordingly in FIG. 6A to illustrate the user's unavailability. In this example, the user, however, chooses to reschedule his conference 620 from Wednesday 606 to Monday 602 with a start time of 9:00 (reference numeral 610a) and an end time of 10:00 (reference numeral 610b), as shown by the arrow extending from Wednesday to Monday. After the new time range of unavailability has been entered using an appropriate calendar application on a client device such as computer 402 (FIG. 4), one of the information appliances 105-1 to 105-M or MCD 116 (FIG. 1), and that information has been propagated to server 404 (FIG. 4), the collection of meetings 614, 618 and the conference 620 on Monday 602 create three separate start times of 8:00 (reference numeral 608a), 9:00 (reference numeral 610a), and 10:00 (reference numeral 612a) and three separate end times of 9:00 (reference numeral 608b), 10:00 (reference numeral 610b), and 11:00 (reference numeral 612b) for the three separate, but contiguous time ranges of 8:00 to 9:00, 9:00 to 10:00, and 10:00 to 11:00 (reference numerals 608, 610 and 612, respectively). In a conventional calendar information representation scheme, each of these time ranges with corresponding starting and ending points would be stored in the data structure. Thus, if the conventional scheme were used, when transmitting the users' calendar and availability (or, more relevantly, unavailability) to another party or entity, such as another user, or a mobile communications device, the three separate time ranges 608, 610, and 612 with the six data points (reference numerals 608a, 608b, 610a, 610b, 612a, 612b) would need to be sent.

In accord with an aspect of the present patent application, however, the data points for the collection on Monday 602 are processed and condensed to make storage and transmission of the data more efficient. The result of this is reflected in table 600B of FIG. 6B, where the meeting starting at 8:00 (reference numeral 608a), the conference starting at 9:00 (reference numeral 610a) and the meeting starting at 10:00 (reference numeral 612a) are indicated as a single block of unavailable time for the user beginning at the earliest start time of 8:00 (reference numeral 608a) and ending at the latest of end times of 11:00 (reference numeral 612b).

The analysis and determination of the process to form this union of unavailable user time may be illustrated in the following manner. As the start time of the conference 616 is 9:00 which is later than the 8:00 start time of the meeting 614, this start time of the conference is eliminated from the collection by the process and not stored as a data point. Similarly, the start time of the meeting 618 at 10:00 (reference numeral 612a) is a later start time than the 8:00 start time (reference numeral 608a) for the earlier meeting 614. The process of manipulating and condensing the data eliminates this entry, so that only the earliest start time of 8:00 (reference numeral 608a) is maintained. For storage of the latest end time of the collection, a similar comparative analysis is made by the process to determine the latest end time. The end time of the meeting 614 occurs at 9:00 (reference numeral 608b) and the end time of the conference occurs at 10:00 (reference numeral 610b). Each of these appointments or schedules has an earlier end time compared with the 11:00 end time (reference numeral 612b) for meeting 618. The process deletes the 9:00 and 10:00 end times (reference numerals 608b and 610b) and stores only the 11:00 end time (reference numeral 612b). This forms the new time range of unavailable time for the user from 8:00 (reference numeral 608a) until 11:00 (reference numeral 612b) for Monday 602 for this particular week 601 on the calendar/scheduling application. Prior to manipulating and condensing the data, there were six data points for this time range—three start times 608a, 610a, 612a and three end times 608b, 610b, 612b. After the process condenses the data, there are only two data points—a single start time (reference numeral 608a) and a single end time (reference numeral 612b)—for storage, transmission, or both.

One skilled in the art will understand that in certain implementations, in order to condense the several appointments, it must first be determined that all of the appointments to be condensed are either contiguous or overlapping. If non-overlapping or non-contiguous appointments are condensed, some blocks of time during which the user is actually available will be shown as unavailable. Furthermore, in some example implementations, the determination step may in turn require the availability time slots to be sorted by one of start date/time or end date/time (or referenced by an equivalent tree) to allow the process to operate in order N time as opposed to order N-squared. Additionally, the data structures for storing appointments may employ an array or grid having a small number of fixed time boundaries (as shown FIG. 6A for example) or instead comprise a list, tree or other structure containing a plurality of appointment descriptions with arbitrary start and end times. If the former, then no sorting may be needed because appointments are stored in fixed slots. If the latter, then sorting may be needed and overlapping appointments must be appropriately handled.

It should be understood by those of skill in the art that the analysis of the time ranges may start with either the start times or the end times of the collection, and possibly in any order of pair-wise comparisons. Basically, appropriate compression logic is operable to process the time range data and determine min{(start times)ᵢ; i=1 to N} and max{(end times)ᵢ; i=1 to N}, with suitable clock arithmetic being used. Clearly, certain implementations may involve computations with 24-hour military time, AM/PM considerations, country/time zone variations, or having only start times, or where an offset-based timing is used (e.g., an offset from a computer epoch), and the like.

With reference to FIGS. 6C and 6D, there is shown another example of the process for condensing user unavailability data for storage. There are meetings 614 and 618 entered into a calendar application data structure 600C with time ranges of 8:00-9:00 (reference numerals 608a and 608b) and 10:00-11:00 (reference numerals 612a and 612b). In this example, the new time entry for a conference 616 is not contiguous with the Monday 602 meeting 614 which has an end time of 9:00 (reference numeral 608b). Rather, the conference entry overlaps the meeting 614 and has a start time of 8:30 (reference numeral 608c). The conference end time of 10:15 (reference numeral 612c) also overlaps the start time of 10:00 for meeting 618.

In accordance with the teachings of the present application, the start times of the three appointment time ranges 8:00, 8:30 and 10:00 (reference numerals 608a, 608c and 612a, respectively) are compared to identify and determine the earliest start time. The process stores only the earliest start time of 8:00 (reference numeral 608a) and, therefore, deletes the other data points. The three end times of 9:00, 10:15 and 11:00 (reference numerals 608b, 612c, 612b) are likewise compared to determine the latest end time. The process deletes the 9:00 and 10:15 end times (reference numerals 608b and 612c) and stores only the 11:00 end time (reference numeral 612b). This forms the new time range of unavailable time for the user from 8:00 (reference numeral 608a) until 11:00 (reference numeral 612b) for Monday 602 for this particular week 601 on the calendar application.

The process condenses the appointment data in this scenario to repackage and form the user unavailability time range shown as a union of time ranges from 8:00 to 11:00 in the collection 630 represented as the shaded area in FIG. 6D that is illustrative of an after-process database structure 600D. The condensed appointment data has only a single start time of 8:00 (reference numeral 608a) and a single end time of 11:00 (reference numeral 612b). Similar to the description above with respect to FIGS. 6A and 6B, it is only these start and end times of the appointment data that are stored for the users' unavailability. This condensed user unavailability data can be transmitted to another entity, for example, a desktop or computer disposed within an enterprise network, a network node disposed in a telecommunications network, or a mobile communications device. In this manner, when an individual sends out a request for the availability of other users based on the respective calendar information of those users, less appointment data needs to be transmitted to the requesting individual. It should be understood by those skilled in the art that a new appointment entry which overlaps only one other appointment, that is, having overlap with a single start time or single end time of another appointment would create the union of the two entries from the earliest start time to the latest end time.

As alluded to previously, those skilled in the art will recognize upon reference hereto that the example data structures shown in FIGS. 5, 6A-6D are purely illustrative for purposes of providing an explanation of the teachings of the present disclosure and bear no relationship to actual storage, format, or organization in a specific implementation. Likewise, how the timestamps (e.g., start and end times, which may or may not comprise whole-hour boundaries) of respective appointments are actually stored or organized into a data structure is not represented in these Figures. Accordingly, it should be appreciated that the time range compression process set forth herein may be applied to at least a portion or subset of the appointment ranges that is contiguous or overlapping, regardless of whether such ranges have whole- or partial-hour boundaries.

As indicated above, the user availability/unavailability information may be transmitted to a mobile communications device. FIG. 7 depicts a block diagram of a mobile communications device operable according to one embodiment that includes appropriate functionality to request and process compressed user availability data. A microprocessor 702 providing for the overall control of an embodiment of MCD 116 is operably coupled to a communication subsystem 704 which includes a receiver 708 and transmitter 714 as well as associated components such as one or more local oscillator (LO) modules 710 and a processing module such as a digital signal processor (DSP) 712. As will be apparent to those skilled in the field of communications, the particular design of the communication module 704 may be dependent upon the communications network with which the mobile device is intended to operate. In one embodiment, the communication module 704 is operable with both voice and data communications. Regardless of the particular design, however, signals received by antenna 706 from base station 114 (see also FIG. 1) are provided to receiver 708, which may perform such common receiver functions as signal amplification, frequency down conversion, filtering, channel selection, analog-to-digital (A/D) conversion, and the like. Similarly, signals to be transmitted are processed, including modulation and encoding, for example, by DSP 712, and provided to transmitter 714 for digital-to-analog (D/A) conversion, frequency up conversion, filtering, amplification and transmission over the air-radio interface via antenna 716.

Microprocessor 702 also interfaces with further device subsystems such as auxiliary input/output (I/O) 718, serial port 720, display 722, keyboard 724, speaker 726, microphone 728, random access memory (RAM) 730, other communications facilities 732, which may include for example a short-range communications subsystem, and any other device subsystems generally labeled as reference numeral 733. To control access, a Subscriber Identity Module (SIM) or Removable user Identity Module (RUIM) interface 734 is also provided in communication with the microprocessor 702. In one implementation, SIM/RUIM interface 734 is operable with a SIM/RUIM card having a number of key configurations 744 and other information 746 such as identification and subscriber-related data.

Operating system software and transport stack software may be embodied in a persistent storage module 735 (i.e., non-volatile storage) which may be implemented using Flash memory or another appropriate memory. In one implementation, persistent storage module 735 may be segregated into different areas, e.g., storage area for computer programs 736 (which may include operation system software) and transport stack 206, as well as data storage regions such as device state 737, address book 739, other personal information manager (PIM) data 741, and other data storage areas generally labeled as reference numeral 743. Additionally, an application client module 748 (e.g., a calendar/scheduling application client or any other client operable with user availability data) is provided for accessing and/or processing user availability information according to the teachings set forth hereinabove.

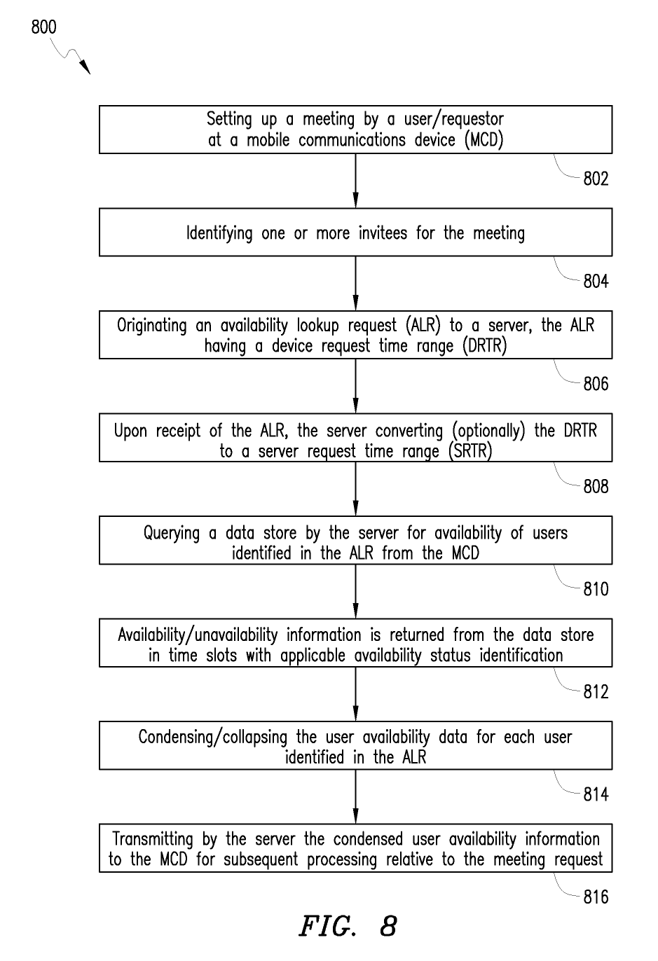

FIG. 8 depicts a flowchart according to one embodiment for providing condensed user availability data with respect to a time-based event transaction (e.g., a meeting request) initiated on a client device, e.g., a handheld device such as MCD 116 or a user desktop computer. A meeting organizer (e.g., the user or the user's agent) may use the handheld device to set up a meeting (block 802), wherein one or more participants may be identified (i.e., invitees) for the meeting (block 804). Once the user selects or otherwise identifies the invitees, the user may opt to request availability information with respect to the invitees. Accordingly, an availability lookup request (ALR) may be originated by the organizer towards a server, specifying addresses of the invitees (e.g., email addresses) and some time range of interest (known as “device request time range” or DRTR) over which the availability information is being requested (block 806). If the time range is not specified, a default range may be provided (e.g., 2 weeks from the initial meeting request). Upon receipt of the ALR, the server may optionally convert the received DRTR to an equivalent time range that is specific to the server (known as “server request time range” or SRTR) (block 808) and query a data store for the invitees' availability for the period specified in the SRTR (block 810). The SRTR may be calculated in an implementation-specific way and may be configurable. For example, in a Lotus Domino-based implementation, the SRTR may be configured to be two months from the start time of DRTR. In an Exchange® implementation, the SRTR may be configured to be two months from the first date of the current month. Likewise, the availability queries to the data store may also be implementation-specific and may use either standard or custom application programming interfaces (APIs) or calls. By way of illustration, the following is an API call in a Lotus Domino-based implementation:

SchSrvRetrieveExt, SchContainer_GetFirstSchedule,
Schedule_ExtractSchedList, Schedule_ExtractMoreSchedList,
SchContainer_GetNextSchedule, SchContainer_Free.

Responsive to the query from the server, the data store returns the availability (or, conversely, unavailability) information for the identified invitees in terms of time slots, for example, that may be flagged with appropriate status identifiers, such as “Busy”, “Tentative”, “Available”, and the like (block 812). The server may be configured to place the time slot information into a suitable C++ structure with the following example definition:

```
{
    StartTime; // Seconds
    EndTime; // Seconds
}
```

The structure with time slot information may be merged with the status information for a particular invitee on a status-by-status basis. Once the availability/unavailability information is received, the server may then apply the service logic to condense the time slot data for each user identified in the ALR as described in detail in the foregoing sections (block 814). Thereafter, the server may truncate the condensed availability information to the boundaries of the DRTR and combine the availability data for all the identified invitees. The condensed user availability information over the applicable time range is then transmitted to the MCD that originated the ALR, whereupon the meeting organizer may undertake a number of operations relative to the meeting request (block 816). For instance, the organizer may select an appropriate time slot based on the received condensed user availability information for scheduling or rescheduling the meeting. The selected time slot may then be transmitted to the server application for facilitating access by others.

In an example implementation, availability information retrieved from the data store may be cached by the server, possibly with a configurable life time (e.g., minutes). Also, the server is operable to determine whether the condensed user availability information fits into one packet for transmission to the requesting MCD. If the data is too large, it may be split into several blocks prior to transmission. As to subsequent requests for user availability, the server may be configured to check whether the availability information over the applicable time range is already available in its cache for a particular invitee. If so, the server may not query the data store for that particular invitee.

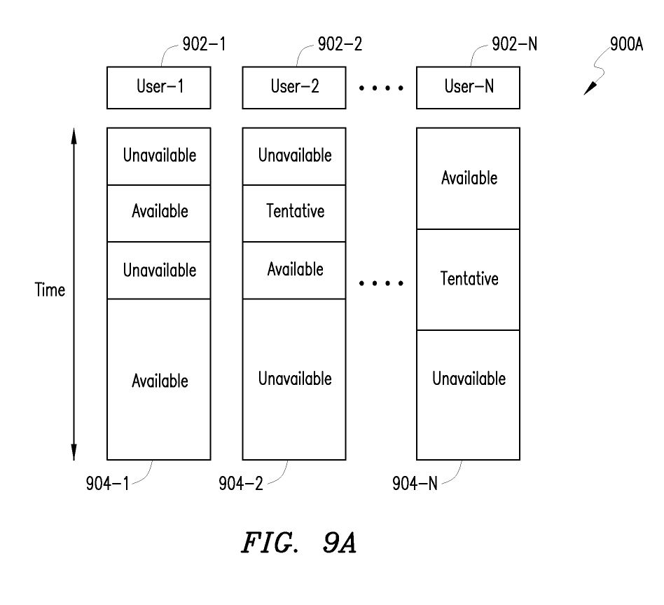

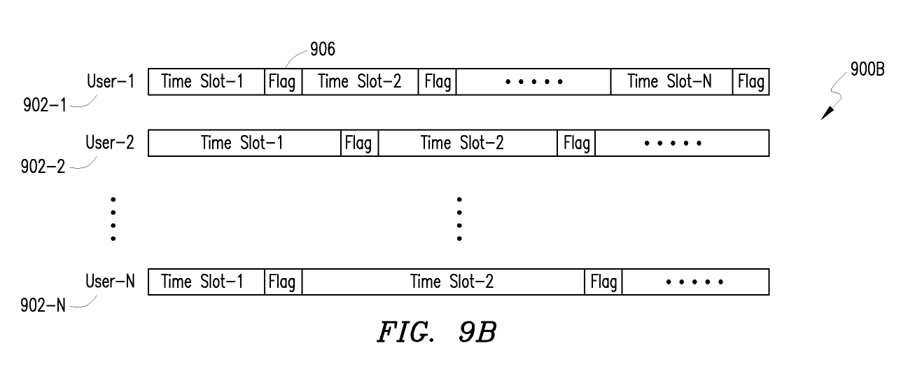

FIGS. 9A and 9B depict examples of data structures according to one embodiment with respect to uncondensed user availability information. Reference numeral 900A refers to availability/unavailability information in time slots for a number of users 902-1 through 902-N as may be stored in a data store that a server can query. For each user, a periodic time range (e.g., daily) may be marked with boundaries of time slots, each time slot being identified appropriately with respect to the user's availability. By way of illustration, reference numerals 904-1 through 904-N refer to the time ranges that correspond to users 902-1 to 902-N, wherein the time slots can be representative of various time-based events or activities, e.g., meetings, appointments, conferences, travel schedules, engagements, and the like. In the embodiment of FIG. 9B, reference numeral 900B refers to the uncondensed availability data for users 902-1 to 902-N wherein various time slots are appropriately provided with a status flag, e.g., flag 906, to indicate availability or unavailability. Based on the techniques discussed hereinabove, the service logic associated with the server is operable to use the status flag information to condense all available/unavailable time slots on a user by user basis in order to facilitate better transmission and storage of availability data. It should be recognized by one skilled in the art that because of the complementary nature of a user's availability and unavailability, the term “availability data” may include the time slot information when a user is available, and conversely, the time slot information when the user is not available.

It should be recognized that various processes, structures, components and functions set forth above in detail, associated with an application server, remote services server or a mobile communications device, may be embodied in software, firmware, hardware, or in any combination thereof, and may accordingly comprise suitable computer-implemented methods or systems for purposes of the present disclosure. Where the processes are embodied in software, such software may comprise program instructions that form a computer program product, instructions on a computer-accessible media, uploadable service application software, or software downloadable from a remote station, and the like. Further, where the processes, data structures, or both, are stored in computer accessible storage, such storage may include semiconductor memory, internal and external computer storage media and encompasses, but is not limited to, nonvolatile media, volatile media, and transmission media. Nonvolatile media may include CD-ROMs, magnetic tapes, PROMs, Flash memory, or optical media. Volatile media may include dynamic memory, caches, RAMs, etc. Transmission media may include carrier waves or other signal-bearing media. As used herein, the phrase “computer-accessible medium” encompasses “computer-readable medium” as well as “computer executable medium.”

Additionally, it will be further recognized by those skilled in the art upon reference hereto that the arrangements set forth in the Figures of the present application may comprise a number of variations and modifications, in hardware, software, firmware, or in any combination, usually in association with a processing system where needed, as components configured to perform specific functions. Accordingly, the arrangements of the Figures should be taken as illustrative rather than limiting with respect to the embodiments of the present patent application.

It is believed that the operation and construction of the embodiments of the present patent application will be apparent from the Detailed Description set forth above. While the exemplary embodiments shown and described may have been characterized as being preferred, it should be readily understood that various changes and modifications could be made therein without departing from the scope of the present disclosure as set forth in the following claims.

What is claimed is:

1. A computer-implemented method for processing availability data of a user, said availability data relating to one or more time slots in a time range associated with said user and each time slot having a start time and an end time, said method comprising:
selecting a subset of time slots for compression;
determining an earliest of start times and a latest of end times associated with said subset of time slots; and
storing only said earliest of start times and said latest of end times associated with said subset of time slots for said user to condense said availability data.

2. The computer-implemented method of claim 1, further comprising transmitting only said earliest start time and said latest end time of said subset of time slots of said user to another party.

3. The computer-implemented method of claim 1, wherein said earliest start time and said latest end time of said subset of time slots are transmitted to a mobile communications device.

4. The computer-implemented method of claim 1, wherein said earliest start time and said latest end time of said subset of time slots are transmitted to a desktop computer.

5. The computer-implemented method of claim 1, wherein said earliest start time and said latest end time of said subset of time slots are transmitted to a network node.

6. The computer-implemented method of claim 1, wherein said start times and said end times are stored in a Standard Template Library structure.

7. The computer-implemented method of claim 1, wherein said start times and said end times are stored in a database associated with a calendaring application.

8. The computer-implemented method of claim 1, wherein said subset of time slots comprises at least one of contiguous time slots and overlapping time slots.

9. The computer-implemented method of claim 1, wherein said selecting said subset of time slots is performed after receiving an availability lookup request from an organizer of a meeting, said availability lookup request identifying said user as an invitee of said meeting.

10. The computer-implemented method of claim 9, further comprising transmitting said condensed availability data to said organizer of said meeting.

11. The computer-implemented method of claim 10, wherein said organizer of said meeting generates said availability lookup request on one of a mobile communications device and a desktop computer.

12. A computer-implemented method for processing availability information relating to a user, said method comprising:
receiving a request for user availability information;
obtaining time slot data for said user relating to one or more time-based activities of said user, each time slot having a start time and an end time;
selecting a subset of said time slots that are contiguous or overlapping;
determining an earliest of start times and a latest of end times for said subset of time slots; and
storing only said earliest start time and said latest end time as a single block of time for said user.

13. The computer-implemented method of claim 12, further comprising transmitting only said earliest start time and said latest end time for said user to another entity.

14. The computer-implemented method of claim 13, wherein said another entity comprises at least one of a mobile communications device, a desktop computer, and a network node.

15. A computer-implemented system for processing availability data of a user, said availability data relating to one or more time slots in a time range associated with said user and each time slot having a start time and an end time, said system comprising:
a component configured to select a subset of time slots that are contiguous or overlapping;
a component configured to identify an earliest of start times and a latest of end times associated with said subset of time slots; and
a component configured to facilitate storage of only said earliest start time and said latest end time of said subset of time slots for said user.

16. The computer-implemented system of claim 15, further comprising a component configured to facilitate transmission of said earliest start time and said latest end time associated with said subset of time slots of said user to another party.

17. The computer-implemented system of claim 15, further comprising a component configured to facilitate transmission of said earliest start time and said latest start time to a mobile communications device.

18. The computer-implemented system of claim 15, further comprising a component configured to facilitate transmission of said earliest start time and said latest start time to a desktop computer.

19. The computer-implemented system of claim 15, further comprising a component configured to facilitate transmission of said earliest start time and said latest start time to a network node.

20. The computer-implemented system of claim 15, wherein said start time and said end time of said time slots are stored in a Standard Template Library structure.

21. The computer-implemented system of claim 15, wherein said start time and said end time of said time slots are stored in a database associated with a calendaring application.

22. A mobile communications device, comprising:
a component configured to generate a request for availability information towards a server, said availability information relating to one or more users; and
a component configured to process condensed availability information received from said server, wherein said condensed availability information comprises only an earliest of start times and a latest of end times associated with time slots corresponding to multiple time-based activities on a user-by-user basis.

23. In a calendaring system on a remote mobile communications device disposed in a communication relationship with a server, a method for scheduling a meeting involving a plurality of users, said method comprising:
identifying said plurality of users as invitees with respect to said meeting;
originating an availability lookup request (ALR) to said server, said ALR including address information of said invitees;
receiving condensed availability information relating to said invitees, said condensed availability information identifying a start time and an end time for each invitee, wherein said start time is an earliest of start times of one or more time slots of a time range associated with said each invitee and said end time is a latest of end times of said one or more time slots; and
responsive to said condensed availability information, choosing an appropriate time slot for scheduling said meeting and transmitting said appropriate time slot to said server.

24. The method of claim 23, wherein said time slots comprise time slots that are contiguous.

25. The method of claim 23, wherein said time slots comprise time slots that are overlapping.

26. The method of claim 23, wherein said time slots comprise time slots that correspond to time-based activities selected from at least one of meetings, appointments, conferences and engagements.

27. The method of claim 23, wherein said time slots comprise time slots that are identified with an availability status flag.

28. The method of claim 23, wherein said time slots comprise time slots that are identified with an unavailability status flag.
